(19) United States
(12) Patent Application Publication
(10) Pub. No.: US 2005/0048292 A1
(43) Pub. Date: Mar. 3, 2005

(54) Composite plastic material

(76) Inventors: Jarod R. Hammar, Fairport, NY (US); Stefan Pitolaj, Walworth, NY (US)

Correspondence Address: John M. Harrington;Kilpatrick Stockton LLP, 1001 West Fourth Street, Winston-Salem, NC, 27101, US

(21) Appl. No.: 10/846,134

(22) Filed: May 14, 2004

Related U.S. Application Data
(60) Provisional application No. 60/471,215, filed on May 16, 2003.
(60) Provisional application No. 60/500,886, filed on Sep. 5, 2003.

(51) Int. Cl. B32B 27/00

(52) U.S. Cl. 428/422; 428/64.1

(57) ABSTRACT

The present invention relates to a flexible composite plastic material that can be used to fabricate a variety of mechanical goods such as diaphragms. The composite plastic material comprises a layer of rePTFE and a layer of flexible polymer. The composite plastic material may further comprise a layer of thermoplastic polymer between layers of rePTFE and flexible polymer.

### STATEMENT OF RELATED APPLICATIONS

The present application claims priority under 35 U.S.C. §119(e) from U.S. Provisional Application Ser. No. 60/471,215, filed May 16, 2003, entitled “Composite Plastic Structure and Article for Superior Flexure and Toughness Properties,” and from U.S. Provisional Application Ser. No. 60/500,886, filed Sep. 5, 2003, entitled “Composite Plastic Structure and Article for Superior Flexure and Toughness Properties,” the disclosures of which are incorporated herein by reference.

### FIELD OF INVENTION

The present invention relates to a flexible composite plastic material.

### BACKGROUND OF INVENTION

Flexible composite plastic materials can be used to fabricate a variety of mechanical goods such as, but not limited to, tires, hoses, diaphragms, seals, gaskets, tapes, accumulators, airbags, fuel cells, medical tubing, structural bearings and so forth.

In applications where plastic material is repetitively flexed, plastic materials that are too rigid may crease, crack, and eventually fail. Plastic materials that are sufficiently flexible to potentially avoid cracking may be susceptible to tears and propagation of tears. For example, in commercially available composite plastic materials made of a layer of redensified, previously expanded polytetrafluroethylene (rePTFE) and a layer of elastomeric material, the rePTFE layer may have poor flex properties, but exhibit desirable toughness and tear resistance. Conversely, in commercially available composite plastic materials made of a layer of amorphous PTFE (aPTFE) and a layer of elastomerical material, the aPTFE may have excellent flex properties, but exhibit poor toughness and tear resistance. In another example, in two piece diaphragms having an outer PTFE layer and an inner rubber layer, the outer PTFE layer can protect the underlying rubber layer from chemicals and other materials that would cause rapid failure of the rubber alone. PTFE that can adequately protect the inner rubber layer may be too rigid and be prone to cracking and failure.

To potentially overcome problems of cracking and tearing, diaphragms have been prepared having a structure that attempts to minimize the stress on the PTFE layer by having a series of concentric or radial ribs. Fabricating a diaphragm with ribs can make tooling more complex and can reduce the design flexibility of the diaphragm.

Thus, there is a need for materials that have desirable flex properties in combination with desirable toughness and tear resistance.

### SUMMARY OF INVENTION

The present invention provides a composite plastic material comprising the following layers in sequence: a first layer of redensified, previously expanded polytetrafluoroethylene; a layer of thermoplastic polymer; and a layer of flexible polymer. Additional layers of redensified, previously expanded polytetrafluoroethylene, thermoplastic polymer, and/or flexible polymer may be added to the composite material.

The present invention also provides a composite plastic material comprising the following layers in sequence: a first layer comprising redensified, previously expanded polytetrafluroethylene in contact with a second layer comprising a flexible polymer. Additional layers of redensified, previously expanded polytetrafluoroethylene and flexible polymer may be added to the composite material.

The present invention also provides a composite diaphragm comprising a composite plastic material comprising the following layers in sequence: a layer of redensified previously expanded polytetrafluoroethylene; and a layer of reinforced material comprising at least one ply of strengthening fabric combined with a flexible polymer.

### BRIEF DESCRIPTION OF DRAWINGS

FIG. 1 is a cross sectional view of a composite plastic material of the invention.

FIG. 2A is a perspective view of an embodiment of a diaphragm of the invention.

FIG. 2B is a cross sectional perspective view of a diaphragm of FIG. 2A of the invention.

FIG. 3 is a cross section view of a composite plastic material of the invention.

FIG. 4 is a cross sectional view of a diaphragm of the invention comprising the composite plastic material in FIG. 3.

### DETAILED DESCRIPTION

The present invention provides composite plastic materials. In one aspect, the present invention provides a composite plastic material comprising the following layers in sequence: a first layer of redensified, previously expanded polytetrafluoroethylene (rePTFE); a layer of thermoplastic polymer; and a layer of flexible polymer. The composite plastic material may further comprise a layer of thermoplastic polymer; and a second layer of rePTFE. The composite plastic material may be used to construct various articles of manufacture including, but not limited to, a diaphragm.

In another aspect, the present invention provides a composite plastic material comprising the following layers in sequence: a first layer comprising rePTFE in contact with a second layer comprising a flexible polymer. The composite plastic material may further comprise a third layer comprising rePTFE in contact with the second layer. The composite plastic material may be used to construct various articles of manufacture including, but not limited to, a diaphragm.

In another aspect, the present invention provides a composite diaphragm comprising a composite plastic material comprising the following layers in sequence: a layer of rePTFE; and a layer of reinforced material comprising at least one ply of strengthening fabric combined with a flexible polymer. The composite diaphragm may further comprise an elastomeric layer adhered to the layer of reinforced material. A reinforcing fabric may optionally be embedded in the elastomeric layer.

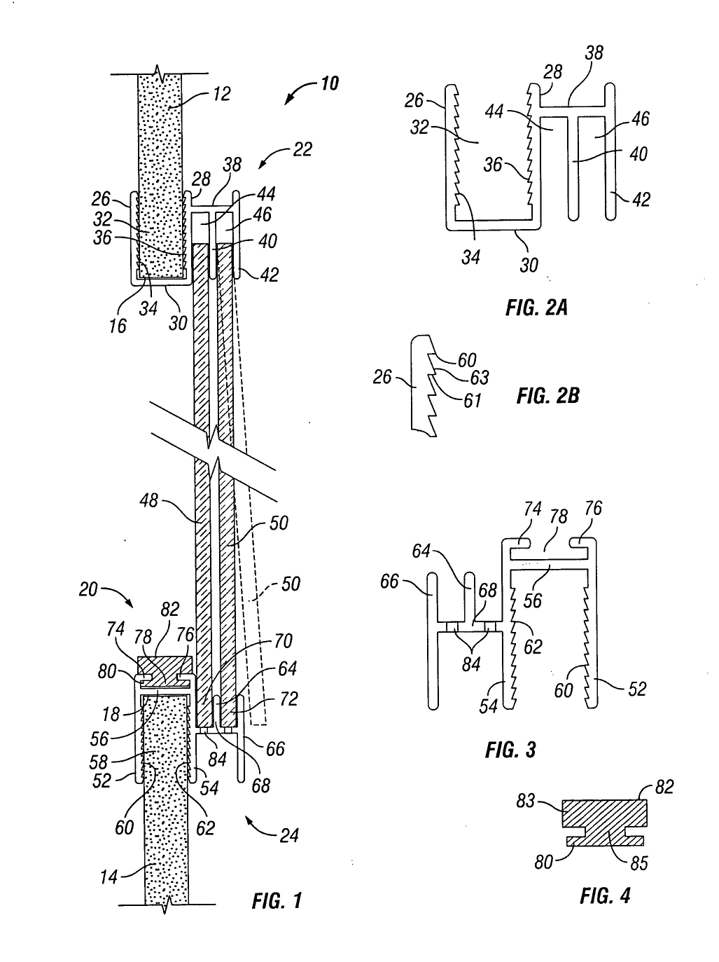

Referring now to the figures, FIG. 1 is a cross section of a composite material 100 of the present invention. The composite material 100 comprises the following layers in sequence: a first layer of rePTFE 170, a layer of thermoplastic polymer 160, and a layer of a flexible polymer 150.

Redensified, previously expanded polytetrafluoroethylene (rePTFE) used in the present invention can be purchased commercially or can be prepared according to methods described in U.S. Pat. Nos. 5,374,473 and 6,080,472.

In the embodiment depicted in FIG. 1, the composite plastic material 100 comprises a layer of rePTFE 170 and is securely adhered to a layer of a flexible polymer 150 by means of a layer of a thermoplastic polymer 160. As used herein, the term thermoplastic polymer may be any thermoplastic polymer having a melting point below the melting point of rePTFE and the melting point of the flexible polymer, and as a result, the thermoplastic polymer is a material other than the rePFTE and the flexible polymer. The coefficient of thermal expansion and contraction for the rePTFE and flexible polymer may be different even if the rePFTE and flexible polymer comprise the same material. Because the thermoplastic polymer has a melting point below the rePTFE and the flexible polymer, the thermoplastic polymer can be in a semi-liquid state as the rePTFE and the flexible polymer contract while cooling. While not wishing to be bound to a particular theory, the difference in melting temperature may allow the thermoplastic polymer to move with the rePFTE and flexible polymer as they contract at potentially different rates.

In addition to having a melting point below the rePTFE and flexible polymer layers, a useful thermoplastic polymer in an embodiment of the present invention may be determined by various factors such as, but not limited to, level of purity of commercially available material, impermeability against highly corrosive chemicals, or other qualities that may be useful in semi-conductor, pharmaceutical, FDA and other chemical applications.

As previously discussed, the melting point of the thermoplastic is below the melting point of the rePTFE and the flexible polymer. In an embodiment, the melting point of the thermoplastic polymer is at least 10° C. below the melting point of the rePTFE and the flexible polymer material. In another embodiment, the melting point of the thermoplastic polymer is less than 310° C. and the melting point of the rePTFE and the flexible polymer are greater than 310° C. In another embodiment, the thermoplastic polymer is a co-polymer of tetrafluoroethylene selected from the group consisting of fluorinated thermoplastics selected from the group consisting of co-polymers of tetraflouroethylene, co-polymers of vinylidine fluoride, co-polymers of chlorotrifluoroethylene, poly olefins, and plasticized polyvinyl chlorides. In another embodiment, the thermoplastic layer comprises a copolymer of perfluoroalkoxy (PFA) which may include a tetrafluoroethylene and perfluoro(propyl vinyl ether) copolymer. The PFA may have a melting point of about 307° C. In another embodiment, the thermoplastic polymer may comprise a copolymer of fluorinated ethylene propylene (FEP). The FEP may have a melting point of about 260° C.

The flexible polymer is either a form of PTFE other than rePTFE or a copolymer of tetrafluoroethylene selected from the group consisting of fluorinated thermoplastics comprising co-polymers of tetrafluoroethylene, co-polymers of vinylidine fluoride, co-polymers of chlorotrifluoroethylene, polyolefins, and plasticized polyvinyl chlorides. In an embodiment, the flexible polymer is amorphous PTFE (aPTFE).

As previously stated, the composite plastic material of the present invention may be used to construct various articles of manufacture such as a diaphragm. When used to construct a diaphragm, an elastomeric layer may be adhered to the composite plastic material. The elastomeric layer may be comprised of an elastomeric polymer which may be thermosetting elastomers or thermoplastic elastomers. Thermosetting elastomers may be selected from the group consisting of fluoroelastomers including those containing hydrogen and those not containing hydrogen, perfluoroelastomers, and fluoroelastomers containing silicone moieties, nitrile elastomers, acrylic elastomers, olefin diene elastomers, chlorosulfonated polyethylene elastomers, polychloroprene elastomers, butyl and halogenated butyl elastomers, styrene-butadiene elastomers, polydiene elastomers and silicone elastomers. Thermoplastic elastomers may be selected from the group consisting of copolyetherester elastomers, polyurethane elastomers, styrene polyolefin block copolymer elastomers, polyamide elastomers, ethylene copolymer elastomers, and thermoplastic elastomers produced by the process of dynamic vulcanization as described in U.S. Pat. No. 4,130,535 to Coran et al. wherein a blend of a curable elastomer and a plastic results in a thermoplastic elastomeric composition. The elastomeric layer may be either in a reinforced or nonreinforced form. The elastomeric layer in reinforced form is comprised of the elastomeric polymer in which is embedded a reinforcing fabric. The reinforcing fabric may be any fabric that is presently used to reinforce elastomers. Such fabrics include fabrics comprised of polymeric fibers such as nylon fibers, polyester fibers, polyaramides fibers, PTFE fibers, and expanded PTFE fibers.

When an elastomeric layer is adhered to a composite plastic material, the surface of the composite plastic material to which the elastomeric layer is adhered may be treated to increase the surface energy the composite's surface. Treatments commonly known in the art include the use of alkali naphthanates, or other surface modifiers, to improve adhesion to polymers.

Referring now to FIGS. 2A and 2B, FIG. 2A is a composite diaphragm 200 in a molded form comprising the composite plastic material in FIG. 1. FIG. 2B is a cross-sectional view of the diaphragm in FIG. 2A. The diaphragm 200 includes convex areas 220 and concave areas 230. The diaphragm may include a peripheral bead 235 as a means for securing the edge of the diaphragm 200. The means for securing the edge of the diaphragm may include other means such as a series of holes (not pictured) around the edge of the diaphragm 200. The composite diaphragm 200 may include a central hole 240 for attachment of the diaphragm 200 to a reciprocating device. As shown in FIG. 2B, the diaphragm 200 comprises the following layers in sequence: a first layer of rePTFE 270, a layer of thermoplastic polymer 260, a layer of a flexible polymer 250, and a fabric reinforced elastomeric layer 280.

Referring now to FIG. 3, a cross section of a composite material 300 is depicted. The composite material 300 comprises the following layers in sequence: a first layer comprising rePTFE 370, a layer of thermoplastic polymer 360, a layer of flexible polymer 350, a layer of thermoplastic polymer 361, and a second layer of rePTFE 371.

Referring now to FIG. 4, a cross section of a molded diaphragm 400 is depicted comprising the composite plastic material in FIG. 3. The diaphragm may include a peripheral bead 435 as a means for securing the edge of the diaphragm 400. The means for securing the edge of the diaphragm may include other means such as a series of holes (not pictured) around the edge of the diaphragm 400. The diaphragm 400 may include a central hole 440 for attachment of the diaphragm 400 to a reciprocating device. The diaphragm comprises the following layers in sequence: a first layer comprising rePTFE 470, a layer of thermoplastic polymer 460, a layer of flexible polymer 450, a layer of thermoplastic polymer 461, a second layer of rePTFE 471, and a fabric reinforced elastomeric layer 480.

In another aspect, the present invention provides a composite diaphragm comprising a composite plastic material comprising the following layers in sequence: a layer of redensified previously expanded polytetrafluoroethylene; and a layer of reinforced material comprising at least one ply of a strengthening fabric combined with a flexible polymer. In an embodiment, the composite diaphragm may further comprise an elastomeric layer adhered to the layer of reinforced material. The strengthening fabric comprises any fabric compatible with the processing steps used to prepare the composite plastic material such as the temperature. Examples of potentially useful strengthening fabrics include, but are not limited to, fabrics comprised of strengthening fibers such PTFE fibers, expanded porous PTFE fibers (ePTFE), aramids fibers such as para-aramid and meta-aramid fibers, and liquid crystal polymer fibers. In an embodiment, the strengthening fabric may comprise ePTFE fiber. The layer of reinforced material may comprise a strengthening fabric either laminated, coated, or saturated with a flexible polymer. Subsequently, such individually coated strengthening fabric layers (or plies) can be combined into multiple ply constructions. Such multiple ply constructions can be combined using plies based on other reinforcing fabrics. Single plies can be woven from a strengthening fiber and combined with other fibers (such as quartz, glass, aramids or nylon) so long as the other fibers are compatible with the processing steps used to prepare the composite plastic material. In a further embodiment, the composite diaphragm may further comprise a thermoplastic polymer layer between the layer of the rePTFE and the layer of reinforced material and/or between layers of reinforced material. In another embodiment, the composite diaphragm may comprise a layer of reinforced material comprising in sequence a layer of flexible polymer, a layer of thermoplastic polymer, at least one ply of fabric comprising strengthening fabric, a layer of thermoplastic polymer, and a layer of a flexible polymer.

A strengthening fabric comprising fibers such as, but not limited to, ePTFE fiber may be laminated, coated or saturated with the flexible polymer by a solution coating, melt coating, calendaring, extruding, laminating, press molding, roto-molding, thermo-forming, or vacuum forming processes. The resulting reinforced material forms an integral article.

In each aspect of the present invention, where the composite plastic material is used to prepare a diaphragm, the composite plastic material may comprise a series of radial ribs and/or series of concentric ribs. Where a diaphragm further comprises an elastomeric layer, the diaphragm may also comprise a series of concentrically arranged elastomeric ribs formed in the elastomeric layer. Further, a diaphragm comprising a composite plastic material and an elastomeric layer may comprise radial ribs formed in the composite plastic layer and a series of concentrically arranged elastomeric ribs formed in the elastomeric layer.

In each of the aspects of the present invention, the thickness of the layers of rePTFE, thermoplastic polymer, and/or flexible polymer may be determined by various factors such as but not limited to, the ultimate intended use of the composite plastic material, the cost and availability of various thicknesses of materials from commercial suppliers, and size of the article manufactured. For example, when used to prepare diaphragms, the thickness of the rePTFE layer and the flexible polymer can be chosen to provide an appropriate balance between toughness, flexibility, and tear resistance such that the performance of the diaphragm is improved relative to diaphragms prepared solely from rePTFE or aPTFE. In another example where resistance to permeation is desirable, a thermoplastic polymer layer comprising materials resistant to permeation such as, but not limited to, PFA and FEP, the thickness of the thermoplastic polymer layer may be increased relative to the thickness of rePTFE and flexible polymer. As a result, any ratio between the thicknesses of the rePTFE layer and flexible polymer layer is contemplated in the present invention. Further, in embodiments where multiple layers of rePTFE are present, each layer of rePFTE may have the same or different thickness. Similarly, multiple layers of flexible polymer and thermoplastic polymer may also have the same or different thicknesses, respectively. In an embodiment where the composite plastic material is used to prepare a diaphragm, the thickness of the layer(s) of rePTFE may be less than or equal to the thickness of the layer of flexible polymer. In another embodiment where the composite plastic material is used to prepare a diaphragm, the thickness of the layers of rePTFE and flexible polymer are greater than the thickness of the layer(s) of thermoplastic polymer.

The layers of the various composite materials described herein may be adhered to one another through any known means. In an embodiment, the rePTFE, thermoplastic polymer, and flexible polymer may be adhered to each other through the introduction of a sufficient amount of heat and pressure.

A diaphragm may be constructed by pressure laminating, press molding, autoclave molding, roto-molding, hot roll lamination, vacuum forming or thermo-forming processes so long as the method does not compromise the integrity of the composite material. In order to produce a composite diaphragm in a molded form, a molding process can be performed. The various layers which comprise the composite plastic material of a diaphragm are arranged in a mold having a desired shape. The shape may be flat or curved as shown in FIGS. 2A, 2B and 4. A mold containing the various layers may then be subjected to a sufficient amount of heat and pressure through press molding, autoclave molding, roto-molding, vacuum forming or thermoforming processes such that the layers conform to the mold and retain the desired shape upon removal from the mold.

Any of the above mentioned composite materials or diaphragms may have one or all layers in the composite pigmented for color-coding and/or one or all layers in the composite may be filled with a filler to achieve a specific goal. An example of a filler includes, but is not limited to, graphite particles which may conduct electricity. Many air operated double diaphragm (AODD) and single diaphragm metering pumps (SDMP) applications require a conductive diaphragm for static dissipation and intrinsic safety of the pump equipment. In an embodiment, one or all of the layers are filled with a conductive filler that can impart the properties of conductivity to the material.

The following illustrative examples are intended to demonstrate certain aspects of the invention and should not be construed as limiting.

### EXAMPLES

### Example 1

A composite plastic material 100 as shown in FIG. 1 was prepared having a rePTFE layer 170 of 0.020 inches (0.5 mm), a PFA layer 160 of 0.010 inches (0.25 mm), and an aPTFE layer 150 of 0.040 inches (1.0 mm). The layers were placed in a hot press for a period sufficient to melt each of the layers and cooled under pressure to solidify each of the layers.

### Example 2

Using the method described in Example 1, a composite plastic material 300 was prepared having a rePTFE layer 370 of 0.020 inches (0.50 mm), a PFA layer 360 of 0.010 inches (0.25 mm), an aPTFE layer 350 of 0.040 inches(1.0 mm), a PFA layer 361 of 0.010 inches (0.25 mm), and a rePTFE layer 371 of 0.020 inches (0.50 mm).

### Example 3

Using the method described in Example 1, a composite plastic material 100 was prepared having a rePTFE layer 170 of 0.040 (1.0 mm), a PFA layer 160 of 0.010 inches (0.25 mm), and an aPTFE layer 150 of 0.040 inches (1.0 mm).

### Example 4 (Comparative)

The material of Example 4 is a commercially available aPTFE material referred to as GLYON® Style 3527 available from Garlock Sealing Technologies having a thickness of 0.060 inches (1.52 mm).

### Example 5 (Comparative)

The material of Example 5 is a commercially available aPTFE material referred to as GLYON® Style 3527 available from Garlock Sealing Technologies having a thickness of 0.084 inches (2.13 mm).

The physical properties of the materials described in Examples 1-5 are listed in Table 1 below.

TABLE 1
Physical Properties of Various Materials

| ASTM | | | | | | |
|---|---|---|---|---|---|---|
| Test | | | | | Ex. 4 | Ex. 5 |
| Method | Material Property | Ex. 1 | Ex. 2 | Ex. 3 | (Comp.) | (Comp.) |
| D1708 | Thickness (in) | 0.066 | 0.088 | 0.087 | 0.060 | 0.084 |
| | | [1.68 mm] | [2.23 mm] | [2.20 mm] | [1.52 mm] | [2.13 mm] |
| F36 | Compressibility (%) | 12 | 11 | 12 | 20 | 14 |
| F36 | Recovery (%) | 69 | 63 | 67 | 61 | 65 |
| D1708 | Tensile Strength (psi) | | | | | |
| | Longitudinal | 5004 | 5585 | 4681 | 3599 | 4037 |
| | Transverse | 4332 | 5216 | 4622 | 3566 | 3886 |
| D1708 | Elongation (%) | | | | | |
| | Longitudinal | 275 | 316 | 266 | 218 | 263 |
| | Transverse | 247 | 319 | 261 | 224 | 227 |
| D624 | Tear B Strength (lbs) | | | | | |
| | Longitudinal | 49.9 | 72.8 | 75.0 | 40.2 | 52.2 |
| | Transverse | 49.7 | 67.3 | 72.1 | 38.4 | 50.7 |
| D624 | Tear C Strength (lbs) | | | | | |
| | Longitudinal | 44.2 | 63.6 | 66.2 | 39.4 | 47.0 |
| | Transverse | 43.4 | 63.5 | 64.1 | 36.5 | 46.8 |

The compressibility, recovery, tensile strength, elongation, and tear strength properties of the material in Examples 1-3 indicates that the material in Examples 1-3 has increased toughness and strength as compared to aPTFE (comparative Examples 4-5).

### Example 6

The composite plastic material in Example 3 was laminated with a fabric reinforced elastomeric layer comprising neoprene and nylon fabric. The aPTFE side of the composite plastic material was first chemically etched using sodium ammonia process, spray painted with an adhesive, and then secured to the fabric reinforced elastomeric layer. The entire article was molded into an arched diaphragm having an outer diameter (OD) of 11″ (27.9 cm) under heat and pressure such that it was equivalent to the size and shape of the diaphragm in comparative Example 8.

### Example 7A (Comparative)

A commercially available diaphragm having 11″ OD (27.9 cm) constructed with a single layer of 0.040″ (1.0 mm) rePTFE with neoprene/nylon fabric substrate (See U.S. Pat. No. 5,374,473)was installed and tested in a 2″ (5.1 cm) size AODD pump.

### Example 7B (Comparative)

A commercially available diaphragm identical to Example 7A with the exception of having a 0.060″ layer (1.52 mm) of rePTFE was installed and tested in a 2″ (5.1 cm) size AODD pump.

### Example 8A (Comparative)

A diaphragm having 11″ OD (27.9 cm) was constructed with a single layer of 0.060″ (1.5 mm) aPTFE laminated and a neoprene/nylon fabric substrate. The diaphragm was installed and tested in a 2″ (5.1 mm) size AODD pump.

### Example 8B (Comparative)

A diaphragm identical to Example 8A with the exception of having a 0.080″ layer (2.0 mm) of aPTFE was constructed. The diaphragm was installed and tested in a 2″ (5.1 mm) size AODD pump.

A summary of the following performance tests is provided in Tables 2 and 3 below.

Aluminum Sharps Test

With the relevant diaphragm installed in an AODD pump, the pumped media was water with 4 pounds (1.81 kg) of sharp aluminum metal chips, for the purpose of testing and evaluating puncture and tear propagation resistance of the diaphragm. The pump was operating at ambient temperature with media at 30 psig on the PTFE side and air at 70 psig on the neoprene side. The diaphragms were flex cycled at 4320 CPH (cycles/hour).

Three sets of two diaphragms of Example 6 were tested using the aluminum sharps test procedure above. The composite plastic structure layer of some of the diaphragms were punctured, but the tears did not propagate. The tests were eventually suspended when none of the punctured locations developed propagating tears in the composite plastic structure. The testing time before suspending the test was 310 hours (set 1), 460 hours (set 2), 556 hours (set 3).

Two diaphragms of Example 7A (comparative) were tested using the aluminum sharps test procedure above. The rePTFE layer was punctured, but the puncture locations did not propagate into running tears. The test was suspended after 143 hours when the diaphragms failed by allowing media and air to pass completely through the diaphragm.

Two diaphragms of Example 7B (comparative) were tested using the aluminum sharps test procedure above. The rePTFE layer was punctured, but the puncture locations did not propagate into running tears. The test was suspended after 161 hours when the neoprene/rubber layer was exposed to media.

Two diaphragms of Example 8A (comparative) were tested using the aluminum sharps test procedure above. The aPTFE layer was punctured, and the puncture locations developed tear propagations in the aPTFE. The test was suspended after 1 hour.

Two diaphragms of Example 8B (comparative) were tested using the aluminum sharps test procedure above. The aPTFE layer was punctured, and the puncture locations developed tear propagations in the aPTFE within 30 hours. The test was suspended after 30 hours.

TABLE 2
Summary of Tear Resistance of Diaphragms

| | | Comparative Examples | | | |
|---|---|---|---|---|---|
| Test | Ex. 6 | Ex. 7A | Ex. 7B | Ex. 8A | Ex. 8B |
| Aluminum | >310 hours | 143 hours | 161 hours | 1 hour | 30 hours |
| sharps test | | | | | |

Flexure Test

With the relevant diaphragm installed in an AODD pump, the pump was operating at ambient temperature with water at 30 psig on the media side and air at 70 psig on the elastomeric side. The diaphragms were flex cycled at 4320 CPH (cycles/hour). An operating goal of 9 million of flex cycles was set for the diaphragms.

Two diaphragms of Example 6 were tested using the flexure test procedure above. Each of the diaphragms reached the goal of 9 million and the test was eventually suspended. The average number of flex cycles of the two diaphragms was over 9.2 million and the diaphragms showed no visible sign of cracking or other types of typical stress fatigue when materials such aPFTE are used independently.

Five sets of two diaphragms of Example 7A (comparative) were tested using the flexure test procedure. Only 1 of 5 pumps reached the 9 million goal without failure of the diaphragms. The remaining 4 pumps were halted due to failure of the diaphragms. The average number of flex cycles of the diaphragms was about 6 million cycles. The rePTFE layers in the failed diaphragms developed radial flex fatigue creases in the flexure arch portion. The rePTFE was compromised in the flex creases exposing the neoprene rubber.

Five sets of two diaphragms of Example 8A (comparative) were tested using the flexure test procedure, with the exception that the diaphragms were flexed at a rate of 4,560 CPH. A total of 3 out of 5 pumps reached the 9 million goal without failure of the diaphragm. The remaining two pumps were terminated before reaching 9 million due to failure of diaphragms. The average number of flex cycles of the diaphragms was about 8.5 million cycles. In the diaphragms that failed before 9 million cycles, the aPTFE layers were abraded, ultimately punctured by the metal outer pistons, and developed running tears.

TABLE 3
Summary of Flex Characteristics of Diaphragms

Comparative Examples

| Test | Ex. 6 | Ex. 7B | Ex. 8B |
|---|---|---|---|
| Flexure test (million | >9.2 | 6 | 8.5 |
| cycles, | | | |

In summary, numerous benefits have been described which result from employing the concepts of the invention. The foregoing description of embodiments of the invention has been presented for purposes of illustration and description. It is not intended to be exhaustive or to limit the invention to the precise form disclosed. Obvious modifications or variations are possible in light of the above teachings. The embodiments were chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

1. A composite plastic material comprising the following layers in sequence:
a first layer of redensified, previously expanded polytetrafluoroethylene;
a layer of thermoplastic polymer; and
a layer of flexible polymer.

2. The composite plastic material of claim 1, further comprising a layer of thermoplastic polymer; and a second layer of redensified, previously expanded polytetrafluoroethylene.

3. The composite plastic material of claim 1, wherein the thickness of the first layer is less than or equal to the thickness of the layer of the flexible polymer.

4. The composite plastic material of claim 2, wherein the thicknesses of the first and second layers of redensified, previously expanded polytetrafluoroethylene are less than or equal to the thickness of the layer of a flexible polymer.

5. The composite plastic material of claim 1, wherein the flexible polymer is a co-polymer of tetrafluoroethylene selected from the group consisting of fluorinated thermoplastics comprising co-polymers of tetrafluoroethylene, co-polymers of vinylidine fluoride, co-polymers of chlorotrifluoroethylene, polyolefins, and plasticized polyvinyl chlorides.

6. The composite plastic material of claim 1, wherein the flexible polymer is amorphous polytetrafluoroethylene.

7. The composite plastic material of claim 1, wherein the layer of thermoplastic polymer has a melting point at least 10° C. below the melting point of the redensified, previously expanded polytetrafluoroethylene and the flexible polymer.

8. The composite plastic material of claim 1, wherein the layer of thermoplastic polymer is a co-polymer of tetrafluoroethylene selected from the group consisting of fluorinated thermoplastics comprising co-polymers of tetraflouroethylene, co-polymers of vinylidine fluoride, co-polymers of chlorotrifluoroethylene, polyolefins, and plasticized polyvinyl chlorides.

9. The composite plastic material of claim 1, wherein the layer of thermoplastic polymer comprises a copolymer of tetrafluoroethylene and perfluoro(propylvinylether).

10. A diaphragm comprising the composite plastic material of claim 1.

11. The diaphragm of claim 10 further comprising a series of radial ribs formed in the composite plastic material.

12. The diaphragm of claim 10 further comprising a series of concentric ribs formed in the composite plastic material.

13. A diaphragm comprising the composite plastic material of claim 1 and an elastomeric layer adhered to the layer of a flexible polymer.

14. The diaphragm of claim 13 further comprising a reinforcing fabric embedded in the elastomeric layer.

15. A diaphragm comprising the composite plastic material of claim 2 and an elastomeric layer adhered to the second layer of redensified, previously expanded polytetrafluoroethylene.

16. The diaphragm of claim 15 further comprising a reinforcing fabric embedded in the elastomeric layer.

17. A composite plastic material comprising the following layers in sequence:
a first layer comprising redensified, previously expanded polytetrafluroethylene in contact with
a second layer comprising a flexible polymer.

18. The composite plastic material of claim 17, further comprising a third layer comprising redensified previously expanded polytetrafluroethylene in contact with the second layer.

19. The composite plastic material of claim 17, wherein the thickness of the first layer is less than or equal to the thickness of the second layer.

20. The composite plastic material of claim 18, wherein the thicknesses of the first and third layers are less than or equal to the thickness of the second layer.

21. The composite plastic material of claim 17, wherein the flexible polymer is a co-polymer of tetrafluoroethylene selected from the group consisting of fluorinated thermoplastics consisting of co-polymers of tetrafluoroethylene, co-polymers of vinylidine fluoride, co-polymers of chlorotrifluoroethylene, polyolefins, and plasticized polyvinyl chlorides.

22. The composite plastic material of claim 17, wherein the flexible polymer comprises amorphous polytetrafluoroethylene.

23. A diaphragm comprising the composite plastic material of claim 17.

24. The diaphragm of claim 23 further comprising a series of radial ribs formed in the composite plastic material.

25. The diaphragm of claim 23 further comprising a series of concentric ribs formed in the composite plastic material.

26. A diaphragm comprising the composite plastic material of claim 17 and an elastomeric layer in contact with the second layer.

27. The diaphragm of claim 26 further comprising a reinforcing fabric embedded in the elastomeric layer.

28. A diaphragm comprising the composite plastic material of claim 18 and an elastomeric layer in contact with the second layer.

29. The diaphragm of claim 28 further comprising a reinforcing fabric embedded in the elastomeric layer.

30. A composite diaphragm comprising the following layers in sequence:
a layer of redensified previously expanded polytetrafluoroethylene; and
a layer of reinforced material comprising at least one ply of a strengthening fabric combined with a flexible polymer.

31. The composite diaphragm of claim 30, wherein the strengthening fabric comprises expanded porous polytetrafluoroethylene fibers.

32. The composite diaphragm of claim 30, wherein the flexible polymer is selected from the group consisting of fluorinated thermoplastics comprising copolymers of tetrafluoroethylene, copolymers of vinylidine fluoride, copolymers of chlorotrifluoroethylene, polyolefins, and plasticized polyvinyl chlorides.

33. The composite diaphragm of claim 30, further comprising an elastomeric layer adhered to the layer of composite material.

34. The composite diaphragm of claim 33, further comprising a reinforcing fabric embedded in the elastomeric layer.

35. The composite diaphragm of claim 33, further comprising a series of concentrically arranged elastomeric ribs formed in the elastomeric layer.

36. The composite diaphragm of claim 33, further comprising radially arranged ribs formed in the composite plastic material.

37. The composite diaphragm of claim 33, further comprising a layer of thermoplastic polymer between the layer of redensified, previously expanded ploytetrafluoroethylene and the layer of reinforced material.

38. The composite diaphragm of claim 35, wherein the layer of reinforced material comprises in sequence: a layer of flexible polymer, a layer of thermoplastic polymer, at least one ply of a strengthening fabric, a layer of thermoplastic polymer, and a layer of a flexible polymer.
